(19) United States
(12) Patent Application Publication
(10) Pub. No.: US 2021/0193994 A1
(43) Pub. Date: Jun. 24, 2021

(54) CATHODE MATERIALS

(71) Applicant: Johnson Matthey Public Limited Company, London (GB)

(72) Inventors: James STEVENS, Sonning Common Berkshire (GB); Mark COPLEY, Sonning Common Berkshire (GB); James COOKSON, Sonning Common Berkshire (GB)

(21) Appl. No.: 16/761,312

(22) PCT Filed: Nov. 27, 2018
(86) PCT No.: PCT/GB2018/053415

§ 371 Date: May 4, 2020

(30) Foreign Application Priority Data
Nov. 27, 2017 (GB) 1719637.9

(51) Int. Cl. H01M 4/36; H01M 4/62; H01M 4/58; H01M 10/0525

(52) U.S. Cl. CPC H01M 4/366; H01M 4/625; H01M 2004/028; H01M 10/0525; H01M 4/5825

(57) ABSTRACT

Particulate carbon-coated lithium metal phosphate materials are provided with a copper content less than or equal to 1 ppm. Methods of making such materials are also provided, the methods involving the use of adsorbent materials comprising 2-aminomethylpyridine functional groups to remove copper from iron (II) precursors used in the formation of lithium metal phosphates.

### FIELD OF THE INVENTION

This invention relates to carbon-coated lithium metal phosphate materials with low copper content, methods for the production of such materials, and their use for the preparation of electrodes for secondary lithium ion batteries.

### BACKGROUND OF THE INVENTION

Lithium metal phosphate materials, such as lithium iron phosphate (LFP) and lithium manganese iron phosphate (LMFP), have found widespread use as cathode materials in secondary lithium ion batteries. This is due to the advantageous properties of batteries incorporating such materials, including high power density and good safety profile. The lithium metal phosphate materials used in such batteries are predominantly in the form of particles which are coated with electrically conductive carbon, and are typically produced by melting processes, hydrothermal processes or solid-state processes.

It has been speculated that the presence of low level impurities in such cathode materials can lead to a reduction in battery lifetime. There remains a need for improved processes for the preparation of lithium metal phosphate materials with improved electrochemical performance.

### SUMMARY OF THE INVENTION

It has been surprisingly found that certain adsorbent materials comprising 2-aminomethylpyridine functional groups can be used to remove trace amounts of copper from iron precursors commonly used in the preparation of lithium metal phosphate materials. It has also been found that the use of such methods enables the formation of lithium metal phosphate materials with very low copper content. Such materials have the potential to offer improved electrochemical performance over repeated charge-discharge cycles and therefore an extension of battery lifetime.

Therefore, in a first aspect of the invention there is provided particulate carbon-coated lithium metal phosphate having the formula LiₓFe_{1-Y}Mn_{Y}PO₄ in which 0.8≤x≤1.2 and 0≤y≤0.9 and in which up to 10 atom % of the Fe may be replaced with dopant metal, up to 10 atom % of the phosphate may be replaced with sulfate and/or silicate, and wherein the carbon-coated lithium metal phosphate has a copper content less than or equal to 1 ppm. Preferably, the carbon-coated lithium metal phosphate has a copper content less than or equal to 0.1 ppm, more preferably less than or equal to 0.01 ppm. Such material is obtainable by a process as described herein.

In a second aspect of the invention there is provided a process for the preparation of particulate carbon-coated lithium metal phosphate with a copper content less than or equal to 1 ppm, preferably less than or equal to 0.1 ppm, more preferably less than or equal to 0.01 ppm, the process comprising the steps of (i) contacting an acidic solution of an iron (II) salt with an adsorbent material to form an iron (II) precursor solution, the adsorbent material comprising 2-aminomethylpyridine functional groups; (ii) combining the iron (II) precursor solution with at least one lithium source, at least one phosphate source, optionally at least one manganese source, optionally at least one source of a dopant metal, optionally at least one source of silicate, and optionally at least one source of sulfate, to form a precursor mixture; (iii) obtaining particulate lithium metal phosphate from the precursor mixture under hydrothermal conditions; (iv) contacting the particulate lithium metal phosphate with a carbon source; and (v) heating the particulate lithium metal phosphate and carbon source to form the particulate carbon-coated lithium metal phosphate.

It has been surprisingly found that the adsorbent materials may be used to remove trace amounts of copper even in the presence of high iron (II) concentrations in the initial acidic solution. This enables the use of the methodology for large scale production. Typically, the acidic solution of the iron (II) salt comprises at least 5 wt % iron, preferably at least 6 wt % iron, more preferably at least 8 wt % iron.

Typically, the adsorbent material may comprise, for example, a crosslinked polystyrene resin modified with 2-aminomethylpyridine functional groups or a silicon polymer composite modified with 2-aminomethylpyridine functional groups. The functional group may preferably comprise bis(2-pyridylmethyl)amine.

The lithium metal phosphate materials have particular utility for the preparation of electrodes for secondary lithium ion batteries. Therefore, in further aspects of the invention there are provided an electrode for a secondary lithium ion battery comprising particulate carbon-coated lithium metal phosphate as described herein, and a secondary lithium ion battery comprising such an electrode.

### DETAILED DESCRIPTION OF THE INVENTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

It has been found that certain adsorbent materials may be used to remove very low levels of copper from iron (II) salts which are precursors used in the production of lithium metal phosphate materials. Iron (II) salts have high utility in a number of industrial applications and are readily available. For example, iron (II) sulfate is commercially available as a hydrate, such as the heptahydrate FeSO₄.7H₂O available from Sigma Aldrich. Commercial sources of iron (II) sulfate typically contain copper at levels greater than 5 ppm.

The process as described herein involves a first step of preparing an acidic solution of an iron (II) salt and contacting the acidic solution with an adsorbent material to form an iron (II) precursor solution, the adsorbent material comprising 2-aminomethylpyridine functional groups.

Typically, the iron (II) salt is selected from iron (II) sulfate, iron (II) oxalate, iron (II) chloride, iron (II) nitrate, or iron (II) phosphate (Fe₃(PO₄)₂). Preferably, the iron (II) salt is iron (II) sulfate, such as iron (II) sulfate heptahydrate.

The acidic solution of the iron (II) salt is aqueous and typically has a pH in the range 1 to 3, preferably a pH in the range 1 to 2. The pH of the acidic solution may be adjusted to achieve the desired pH value by the addition of an acid, for example by the addition of sulfuric acid.

The acidic solution of the iron (II) salt is typically prepared with an iron content which is suitable for large scale production. Typically, the iron content in the acidic solution is at least 4 wt %, preferably at least 5 wt %, more preferably at least 6 wt % or at least 7 wt %, even more preferably at least 8 wt %. The maximum iron content of the acidic solution is not particularly limited in the current process but may be, for example, less than about 12 wt %.

The acidic solution of the iron (II) salt is contacted with an adsorbent material comprising 2-aminomethylpyridine groups to form an iron (II) precursor solution. It will be understood by the skilled person that the 2-aminomethylpyridine groups are typically linked to a support structure via the amino group, and that the adsorbent materials include materials with 2-aminomethylpyridine (A) and/or bis-(2-pyridylmethyl)amine (B) groups (each shown linked via the amino group):

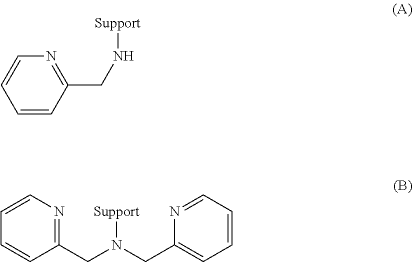

The adsorbent material may comprise a crosslinked polystyrene resin modified with 2-aminomethylpyridine functional groups, such as 2-aminomethylpyridine and/or bis-(2-pyridylmethyl)amine groups. Such resins are commercially available, for example Lewatit® MonoPlus TP220 and DOWEX® M4195 (available from Lenntech BV)

The adsorbent material may also comprise a silicon polymer composite modified with 2-aminomethylpyridine functional groups, for example silica-poly(allylamine)-aminomethylpyridine, which may be known commercially as CuWRAM. The preparation of such materials is described in US2004/0000523A1 which is incorporated herein by reference.

The acidic solution of the iron (II) salt is typically contacted with the adsorbent material by passing the solution of the iron (II) salt through a bed of the adsorbent material.

It has been found that the levels of even trace amounts of copper in iron (II) materials can be reduced through contact with the adsorbent materials, even in the presence of high iron (II) concentrations. Typically, the iron (II) precursor solution after contact with the adsorbent materials has a copper content less than 0.1 ppm, preferably less than 0.075 ppm, less than 0.05 ppm, or less than 0.025 ppm, or even more preferably less than 0.01 ppm. The minimum copper content in the iron (II) precursor solution is not particularly limited, but may be, for example, 0.005 ppm or more.

The copper content of the iron (II) precursor solution which is formed by the process as described herein may be measured, for example, using inductively coupled plasma mass spectrometry (ICP-MS), for example using an Agilent 7700 ICP-MS.

The iron (II) precursor solution may be used to produce lithium metal phosphate materials of the formula LiₓFe_{1-Y}Mn_{Y}PO₄, for example using a hydrothermal process, for example as described in WO2005051840A1.

Such methods involve the combination of the iron (II) precursor solution with at least one lithium source, at least one phosphate source, optionally at least one source of manganese, optionally at least one source of dopant metal, optionally at least one source of silicate, optionally at least one source of sulfate, and obtaining particulate lithium metal phosphate under hydrothermal conditions.

Suitable lithium sources include lithium carbonate (Li₂CO₃), lithium hydrogen phosphate (Li₂HPO₄), lithium hydroxide (LiOH), lithium fluoride (LiF), lithium chloride (LiCl), lithium bromide (LiBr), lithium iodide (LiI), lithium phosphate (Li₂PO₄) or mixtures thereof. Lithium hydroxide may be preferred.

Suitable phosphate sources include phosphoric acid, metaphosphoric acid, pyro-phosphoric acid, triphosphoric acid, tetraphosphoric acid, hydrogen phosphates or dihydrogen phosphates, such as ammonium phosphate or ammonium dihydrogen phosphate, lithium phosphate or iron phosphate or any desired mixtures thereof. Phosphoric acid is particularly preferred.

Suitable manganese sources, if applicable, include MnO, MnO₂, manganese acetate, manganese oxalate, Mn (III) acetylacetonate, Mn (II) acetylacetonate, Mn (II) chloride, MnCO₃, manganese sulfate, manganese nitrate, manganese phosphate, manganocene or mixtures thereof.

Compounds in which up to 10 atom % of the phosphate is replaced with sulfate may be prepared using methods known to those skilled in the art, for example as described in US2015/0232337A1 (Clariant International Ltd). In such cases at least one source of sulfate may be added to the precursor mixture, for example it may be preferred that Li₂SO₄ is added to the precursor mixture as an additional lithium source.

In cases in which up to 10 atom % of the Fe may be replaced with dopant metal, it will be apparent to the skilled person which sources of dopant metal are suitable for inclusion in the precursor mixture, for example halides, nitrates, acetates, carboxylates of the selected metal or metals.

Compounds in which up to 10 atom % of the phosphate is replaced with silicate may be prepared using methods known to those skilled in the art. In such cases at least one source of silicate may be added to the precursor mixture, for example a source of silicate selected from an organosilicon, a silicon alkoxide, tetraethylorthosilicate, Li₂SiO₄, and/or Li₄SiO₄.

In the context of the present invention, the term obtaining particulate lithium metal phosphate from the precursor mixture under hydrothermal conditions is to be understood as treatment of the precursor mixture at a temperature above room temperature and a steam pressure of above 1 bar. The hydrothermal treatment can be carried out in a manner known to the person skilled in the art, for example as described in WO2005/051840 the content of which is hereby incorporated by reference. It is preferable for the hydrothermal treatment to be carried out at temperatures of between 100 to 250° C., in particular from 100 to 180° C. and at a steam pressure of from 1 bar to 40 bar, in particular at a steam pressure from 1 bar to 10 bar. The precursor mixture is typically reacted in a tightly closed or pressure-resistant vessel. The reaction preferably takes place in an inert or protective gas atmosphere. Examples of suitable inert gases include nitrogen, argon, carbon dioxide, carbon monoxide or mixtures thereof. The hydrothermal treatment may, for example, be carried out for 0.5 to 15 hours, in particular for 6 to 11 hours. Purely as a non-limiting example, the following specific conditions may be selected: 1.5 h heat-up time from 50° C. (temperature of the precursor mixture) to 160° C., 10 h hydrothermal treatment at 160° C., 3 h cooling from 160° C. to 30° C.

It may be advantageous to prepare the precursor mixture and to carry out the hydrothermal reaction using apparatus which is arranged such that components which come into contact with the reagents do not comprise copper, for example avoiding apparatus with copper and/or brass fittings.

The lithium metal phosphate is carbon-coated. In order to form the carbon coating, the particulate lithium metal phosphate formed by the hydrothermal process is typically contacted with a carbon source prior to a heating, or calcination step.

The nature of the carbon source is not particularly limited in the present invention. The carbon source is typically a carbon-containing compound which decomposes to a carbonaceous residue when exposed to the calcination step. For example, the carbon source may be one or more of starch, maltodextrin, gelatine, polyol, sugar (such as mannose, fructose, sucrose, lactose, glucose, galactose), and carbon-based polymers such as polyacrylate, polyvinyl acetate (PVA) and polyvinyl butyrate (PVB). Alternatively, the carbon source may be elemental carbon, such as one or more of graphite, carbon black, acetylene black, carbon nanotubes and carbon fibres (such as vapour grown carbon fibres, VGCF). Lactose may be particularly preferred.

The amount of carbon source added is not particularly limited in the present invention. For example, the amount of carbon source added may be selected to yield carbon-coated lithium metal phosphate with a carbon content of 1 to 5 wt %, for example 2 to 3 wt %. The amount of carbon source added may be in the range from 3 to 15 wt % based on the weight of the particulate lithium metal phosphate, for example from 3 to 7 wt %, depending on the nature of the carbon precursor, and its carbonisation yield.

The skilled person will understand that the carbon source may be combined with the particulate lithium metal phosphate by a number of means. For example, the particulate lithium metal phosphate may be subjected to a milling step in the presence of the carbon source, such as a high energy milling step. As one alternative, the lithium metal phosphate may be mixed with the carbon source in the presence of a solvent, such as water, and the mixture then spray dried. It will also be understood by the skilled person that in some cases it may be preferable that the carbon source is added to the precursor mixture prior to hydrothermal treatment. In such a case, it will be understood that step (iv) of the process is no longer required.

In the heating step (v), the particulate lithium metal phosphate and carbon source are heated to provide the particulate carbon-coated lithium metal phosphate. The heating step (v) performs two functions. Firstly, it results in pyrolysis of the carbon source to form a conductive carbon coating on the lithium metal phosphate particles. Secondly, it results in crystallisation of the lithium metal phosphate into the desired olivine structure. Typically, the heating is carried out in an inert atmosphere, for example in an inert gas such as argon. It may alternatively be carried out in a reducing atmosphere. It is typically carried out at a temperature in the range from 550° C. to 800° C., e.g. from 600° C. to 750° C., or from 600° C. or 650° C. to 700° C. 680° C. is particularly suitable. Typically, the calcination is carried out for a period of 3 to 24h. The heating time depends on the scale of manufacture (i.e. where larger quantities are prepared, longer heating times may be preferred). At a commercial scale, 8 to 15 hours may be suitable, for example.

The described process has utility for the preparation of particulate carbon-coated lithium metal phosphate having the formula LiₓFe_{1-Y}Mn_{Y}PO₄ in which 0.8≤x≤1.2 and 0≤y≤0.9 and in which up to 10 atom % of the Fe may be replaced with dopant metal, up to 10 atom % of the phosphate may be replaced with sulfate and/or silicate, and wherein the carbon-coated lithium metal phosphate has a copper content less than or equal to 1 ppm.

Lithium may be present in slightly under or over stoichiometric amounts. The value for x is greater than or equal to 0.8. It may be greater than or equal to 0.9, or greater than or equal to 0.95. The value for x is less than or equal to 1.2. It may be less than or equal to 1.1, or less than or equal to 1.05. The value for x may be 1, or about 1.

The value for y is greater than or equal to 0. It may be greater than or equal to 0.2, or greater than or equal to 0.5, or greater than or equal to 0.65. The value for y is less than or equal to 0.9. It may be less than or equal to 0.85. In a preferred embodiment of the invention, 0.5≤y≤0.9 or more preferably 0.65≤y≤0.9.

The lithium metal phosphate may be doped or non-doped. Therefore, the term “a or the lithium metal phosphate” means within the scope of this invention both a doped or non-doped lithium metal phosphate. Up to 10 atom % of the Fe may be replaced with dopant metal, for example up to 5 atom %. The dopant metal may be one or more selected from Co, Ni, Al, Mg, Sn, Pb, Nb, B, Cr, Mo, Ru, V, Ga, Ca, Sr, Ba, Ti, Zn, Zr, Cd or combinations thereof. Preferably, the dopant metal may be one or more selected from Al, Mg, Ca, Co, Zr, Zn, Cr or combinations thereof. More preferably, the dopant metal is Mg or Al. Where the lithium metal phosphate is doped, typically at least one source of a dopant metal may be added to the precursor mixture prior to hydrothermal treatment. It may be preferred that the lithium metal phosphate is undoped.

Up to 10 atom % of the phosphate of the lithium metal phosphate may be replaced with sulfate and/or silicate. In such cases, at least one source of sulfate and/or silicate is added to the precursor mixture prior to hydrothermal treatment. It may be preferred that the phosphate is not replaced with sulfate and/or silicate.

It may be preferred that particulate carbon-coated lithium metal phosphate having the formula LiₓFe_{1-Y}Mn_{Y}PO₄ in which 0.8≤x≤1.2 and 0≤y≤0.9 is undoped and does not have phosphate replaced with sulfate and/or silicate. In one such case y=0 and has the formula LiFePO₄ which may be particularly preferred.

The stoichiometry of the lithium metal phosphate is typically calculated with reference to the starting materials which it is prepared from, taking into account the yield of the preparation reaction and the purity of the starting materials.

The copper content of the carbon-coated lithium metal phosphate is less than or equal to 1 ppm. Preferably, the carbon-coated lithium metal phosphate has a copper content less than 0.75 ppm, such as less than 0.5 ppm, 0.25 ppm, or more preferably less than 0.1 ppm, 0.075 ppm, 0.05 ppm, 0.025 ppm, or even more preferably less than 0.01 ppm. The minimum copper content in the carbon-coated lithium metal phosphate is not particularly limited, but may be, for example, 0.005 ppm or more.

The copper content of the carbon-coated lithium metal phosphate may be measured, for example, by inductively coupled plasma optical emission spectroscopy (ICP-OES), for example using an Agilent 5110 SVDV ICP-OES.

The nickel content of the carbon-coated lithium metal phosphate may also be beneficially reduced by the process of the invention. In one embodiment of the invention the carbon-coated lithium metal phosphate has a nickel content less than 10 ppm, preferably less than 5 ppm. The minimum nickel content in the carbon-coated lithium metal phosphate is not particularly limited, but may be, for example, 1 ppm or more. The nickel content of the carbon-coated lithium metal phosphate may also be measured, for example, by inductively coupled plasma optical emission spectroscopy (ICP-OES), for example using an Agilent 5110 SVDV ICP-OES.

One formed, the carbon-coated lithium metal phosphate typically has a crystallite size of at least 50 nm when determined by Rietveld analysis of XRD data. The upper limit on the crystallite size is not particularly limited, but may be 500 nm or less, or 200 nm or less. Larger observed crystallite sizes can indicate a higher degree of crystallinity and fewer crystalline defects, which can enhance lithium ion conduction within the lithium metal phosphate material thereby enhancing electrochemical performance.

The process of the present invention may further comprise the step of forming an electrode (typically a cathode) comprising the carbon-coated lithium metal phosphate. Typically, this is carried out by forming a slurry of the particulate carbon-coated lithium metal phosphate, applying the slurry to the surface of a current collector (e.g. an aluminium current collector), and optionally processing (e.g. calendaring) to increase the density of the electrode. The slurry may comprise one or more of a solvent, a binder and additional carbon material.

The process of the present invention may further comprise constructing a battery or electrochemical cell including the electrode comprising the carbon-coated lithium metal phosphate. The battery or cell typically further comprises an anode and an electrolyte.

The battery or cell may typically be a secondary (rechargeable) lithium ion battery. The present invention will now be described with reference to the following examples, which are provided to assist with understanding the present invention, and are not intended to limit its scope.

### EXAMPLES

Analytical Methods

The copper content of the iron (II) sulfate solutions was tested by ICP-MS using the following method:

ICP-MS analysis—The iron sulphate solutions were diluted 1000 times, in duplicate, into 1% HCl and analysed for copper using an Agilent 7700 ICP-MS, against calibration standards of 0 ppb, 0.1 ppb, 0.5 ppb and 5 ppb. The calibration blank and standards are matrix matched to 1% HCl.

The copper content of the lithium iron phosphate materials was tested by ICP-OES using the following method:

ICP-OES analysis—0.2 g of each lithium iron phosphate material was digested into 10 ml of aqua regia, in duplicate, in an Anton Paar Microwave reaction system. To ensure there was no contamination in the microwave vessels, a blank run containing 10 ml aqua regia only, was run through the microwave first and then discarded.

The resulting solutions were then made up to 100 ml in class A volumetric flasks containing yttrium.

These solutions were then run on an Agilent 5110 SVDV ICP-OES, in axial mode for copper against calibration standards of 0 ppm, 0.1 ppm and 0.5 ppm, using yttrium as an internal standard. The calibration blank and standards are matrix matched with 10% aqua regia as well as lithium, iron and phosphorus to the same concentrations as the samples.

The values obtained from the ICP-OES analysis were used to calculate the amount in ppm of copper (and each other element analysed) in the lithium iron phosphate sample.

Testing the Removal of Copper from Model Solutions

A solution was made up by dissolving iron (II) sulfate heptahydrate (754 g, Sigma Aldrich puriss grade) in deionised water (700 ml) and adding 1.0 M sulfuric acid (82 mL). The solution was pH 1.1. The solutions were purged with argon for 1 minute before being capped, any solutions were re-purged if the bottle had to be opened or after sampling.

The solution was divided into 3 portions:

Solution A: as made above.

Solution B: spiked with a copper sulfate solution (Fluka, purum grade) to give a copper content of 20 ppm.

Solution C: spiked with a copper sulfate solution (Fluka, purum grade) to give a copper content of 100 ppm.

The solutions were analysed by ICP-MS to determine copper and iron concentrations

TABLE 1

| | Cu, ppm | Fe, wt % |
|---|---|---|
| Sol. A | 0.22 | 9.21 |
| Sol. B | 21.9 | 9.27 |
| Sol. C | 106 | 9.26 |

A 9.4 mL column was filled with the resins (i) a silica-polyamine composite resin modified with picolylamine (CuWram) under dry conditions (5.13 g dry mass loaded) or (ii) Dowex® M4195 free base form sulfate; a macroporous crosslinked styrene resin modified with di-2(bispicolylamine) as a slurry (3.18 g dry mass loaded). The flow rate was kept at 6 bed volumes (BVs) per hour (0.94 mL/min) using a peristaltic pump, the outlet of the column was collected into polypropylene bottles. The following procedure was then used for both resins.

1. Calibrate pump using deionised water.

2. Rinse resin with 12 bed volumes (BVs) of 20% sulfuric acid solution

3. Wash with 6 BVs deionised water adjusted to pH 1.1 using sulfuric acid.

4. Pass 12 BVs of solution A collected in 2 portions of 6 BVs.

5. Pass 12 BVs of solution B collected in 2 portions of 6 BVs.

6. Pass 12 BVs of solution C collected in 2 portions of 6 BVs.

Samples were collected and submitted for analysis by ICP-MS (Table 2, 3):

TABLE 2
trial results from column
loaded with silica-polymer composite resin CuWram

| | Cu, ppm | | Fe, wt % | |
|---|---|---|---|---|
| Sample | Inlet | Outlet | Inlet | Outlet |
| 1 (56 mL, 6 BVs) | 0.22 | <0.01 | 9.2 | 8.3 |
| 2 (56 mL, 6 BVs) | | <0.01 | | 9.3 |
| 3 (56 mL, 6 BVs) | 21.9 | 0.08 | 9.2 | 9.3 |
| 4 (56 mL, 6 BVs) | | 0.41 | | 9.3 |
| 5 (56 mL, 6 BVs) | 106 | 2.84 | 9.2 | 9.3 |
| 6 (56 mL, 6 BVs) | | 9.16 | | 9.2 |

TABLE 3
trial results from column loaded with Dow M4195

| | Cu, ppm | | Fe, wt % | |
|---|---|---|---|---|
| Sample | Inlet | Outlet | Inlet | Outlet |
| 1 (56 mL, 6 BVs) | 0.22 | <0.01 | 9.2 | 8.2 |
| 2 (56 mL, 6 BVs) | | <0.01 | | 9.3 |
| 3 (56 mL, 6 BVs) | 21.9 | <0.01 | 9.2 | 9.2 |
| 4 (56 mL, 6 BVs) | | <0.01 | | 9.2 |
| 5 (56 mL, 6 BVs) | 106 | <0.01 | 9.2 | 9.3 |
| 6 (56 mL, 6 BVs) | | <0.01 | | 9.3 |

For the column loaded with CuWram resin, the samples with solution A (0.22 ppm Cu) showed no detectable copper (<10 ppb) in the outlet, when the copper concentration of the inlet solution was increased to 20 and 100 ppm with solutions B and C respectively then copper was detectable in the outlet.

The Dow material M4195 removed the copper very efficiently. In this case, as the three solutions were flowed increasing from 0.22 to 100 ppm copper in the inlet, the outlet showed no detectable copper (<10 ppb). The capacity of CuWRAM was lower at the low pH of the experiment, however efficiently removed copper from solution A.

Comparison of the Removal of Copper from Iron (II) Sulfate with Alternative Resins
Dowex® M4195 free base form sulfate; a macroporous crosslinked styrene resin modified with di-2(bispicolylamine).
Lewitat® TP207; a macroporous crosslinked styrene resin modified with iminodiacetate.

A solution of iron (II) sulfate was prepared by dissolving iron (II) sulfate heptahydrate (417 g) in deionised water (1.67 L). The solution was pH 2.1. The solution was filtered through a 0.2 μm nylon filter membrane and purged with argon for 10 minutes before being capped, any solutions were re-purged if the bottle had to be opened. Samples were taken of the solution as made, after filtration and after passing through the column.

9.4 mL columns were filled with (i) Dowex® M4195 free base form sulfate; a macroporous crosslinked styrene resin modified with di-2(bispicolylamine) as a slurry (dry mass loaded 3.20 g) or (ii) Lewitat® TP207; a macroporous crosslinked styrene resin modified with iminodiacetate as a slurry (dry mass 3.25 g). The flow rate was kept at 9 bed volumes (BVs) per hour (1.41 mL/min) using a peristaltic pump, the outlet of the column was collected into glass bottles. The following procedure was then used for both resins.

1. Calibrate pump using deionised water.

2. Rinse resin with 6 BVs of 20% sulfuric acid solution (>95%, Fisher analytical grade)

3. Wash with 6 BVs deionised water.

4. Pass 3 BVs of solution which is discarded to flush water from the column.

5. 162 BVs (1.52 L) pumped through bed and collected.

Samples were collected and submitted for analysis by ICP-MS (Table 4). The samples were purged with Ar before capping the bottles.

TABLE 4
ICP-MS analysis results (ppm)

| | Cu | Ni |
|---|---|---|
| A2 Di-(picolylamine) resin | | |
| initial | 0.45 | 6.9 |
| filtered | 0.47 | 7.1 |
| post column | <0.01 | 1.0 |
| B Iminodiactete resin | | |
| initial | 0.45 | 7 |
| filtered | 0.45 | 7.3 |
| post resin | 0.13 | 6.8 |
| Filtered Only | | |
| C initial | 0.44 | 6.8 |
| C filtered | 0.46 | 7.1 |

The results show that:
The di-(2-picolylamine) resin reduces the copper concentration from 0.45 ppm to below the detection limit of ICP-MS (10 ppb), and the nickel from 6.9 to 1.0 ppm.
The iminodiacetate resin reduced the copper from 0.45 ppm to 0.13 ppm and had little effect on the nickel content.

Preparation of LiFePO₄ (Comparative Example with No Pre-Treatment of FeSO₄)

The equipment used in this preparation had no copper or brass fittings.

A mixture of FeSO₄.7H₂O (Vöst Alp., 16.26 kg), LiOH.H₂O (SQM, 7.05 kg) and H₃PO₄ (Prayron, 75.7%, 7.30 kg) in distilled water was subjected to hydrothermal treatment for 10 h at 160° C. The resulting precipitate was filtered and the filter cake washed with water. The resulting solid was mixed with lactose (10.5 wt %) and water and then the mixture spray dried (Büchi lab spray dryer). The spray dried material was calcined in a laboratory furnace in a nitrogen atmosphere for 3 h at 750° C. The resulting carbon-coated lithium iron phosphate was then milled (Fritsch-mill, 0.08 mm sieve).

The LiFePO₄ was analysed by ICP-OES to quantify the amounts of Cu, Ni and Zn (Table 5)

TABLE 5
ICP-OES analysis of LiFePO₄ (comparative example)

| Sample | Cu (ppm) | Ni (ppm) | Zn (ppm) |
|---|---|---|---|
| After Hydrothermal Reaction | 4 | 75 | 9 |
| After Filtration | 10 | 180 | 25 |
| After Spray Drying | 10 | 160 | 21 |
| After Calcination | 11 | 175 | 22 |
| After Milling | 11 | 175 | 22 |

Preparation of LiFePO₄ with Pre-Treated FeSO₄

The equipment used in this preparation had no copper or brass fittings.

A 0.58 L column (50 mm internal diameter) was slurry loaded with DOW M4195 resin (0.35 kg, 50% dry content), an adjustable end-piece was used to hold the resin in place leaving no void space (approximate resin volume=0.54 L). The resin was washed with 20% sulfuric acid (3 L) and then rinsed with dilute sulfuric acid solution (pH 2.0, 3 L).

An FeSO₄ solution was recirculated through a 1 μm sock filter for 6h. The FeSO₄ solution (55 kg) was then passed through the column at a flow rate of 3 kg/h using a peristaltic pump. The first 3 kg was discarded to avoid dilution of the FeSO₄ solution.

A mixture of FeSO₄ solution (pre-treated, Fe 6.1 wt %, 51.3 kg), LiOH.H₂O (SQM, 7.125 kg) and H₃PO₄ (Prayron, 75.7%, 7.38 kg) in distilled water was subjected to hydrothermal treatment for 10 h at 160° C. The resulting precipitate was filtered and the filter cake washed with water. The resulting solid was mixed with lactose (10.5 wt %) and water and then the mixture spray dried (Büchi lab spray dryer). The spray dried material was calcined in a laboratory furnace in a nitrogen atmosphere for 3 h at 750° C. The resulting carbon-coated lithium iron phosphate was then milled (Fritsch-mill, 0.08 mm sieve). The resultant LiFePO₄ was shown to be crystalline by XRD, contained 2.4 wt % carbon (by CHN analysis) and had a D₅₀ of 0.52 μm by laser diffraction using a Mastersizer 3000 (Malvern).

The LiFePO₄ was analysed by ICP-OES to quantify the amounts of Cu, Ni and Zn (Table 6)

TABLE 6
ICP-OES analysis of LiFePO₄ (pre-treated FeSO₄)

| Sample | Cu (ppm) | Ni (ppm) | Zn (ppm) |
|---|---|---|---|
| After Hydrothermal Reaction | <1 | 2 | 6 |
| After Filtration | <1 | 4 | 11 |
| After Spray Drying | <1 | 3 | 8 |
| After Milling | <1 | 4 | 10 |

The LiFePO₄ prepared from a pre-treated iron sulfate solution showed very low levels of copper (<1 ppm).

1. Particulate carbon-coated lithium metal phosphate having the formula:
LiₓFe_{1-y}Mn_{y}PO₄
in which 0.8≤x≤1.2 and 0≤y≤0.9 and in which up to 10 atom % of the Fe may be replaced with dopant metal, up to 10 atom % of the phosphate may be replaced with sulfate and/or silicate, and wherein the carbon-coated lithium metal phosphate has a copper content less than or equal to 1 ppm.

2. Particulate carbon-coated lithium metal phosphate according to claim 1 with a copper content less than or equal to 0.1 ppm, preferably less than or equal to 0.01 ppm.

3. Particulate carbon-coated lithium metal phosphate according to claim 1 with a nickel content less than or equal to 10 ppm, preferably less than or equal to 5 ppm.

4. Particulate carbon-coated lithium metal phosphate according to claim 1 in which the dopant metal is selected from the group consisting of Co, Ni, Al, Mg, Sn, Pb, Nb, B, Cr, Mo, Ru, V, Ga, Ca, Sr, Ba, Ti, Zn, Zr, Cd or combinations thereof.

5. A process for the preparation of particulate carbon-coated lithium metal phosphate, the process comprising the steps of:
(i) contacting an acidic solution of an iron (II) salt with an adsorbent material to form an iron (II) precursor solution, the adsorbent material comprising 2-aminomethylpyridine functional groups;
(ii) combining the iron (II) precursor solution with at least one lithium source, at least one phosphate source, optionally at least one manganese source, optionally at least one source of a dopant metal, optionally at least one source of silicate, and optionally at least one source of sulfate, to form a precursor mixture;
(iii) obtaining particulate lithium metal phosphate from the precursor mixture under hydrothermal conditions;
(iv) contacting the particulate lithium metal phosphate with a carbon source; and
(v) heating the particulate lithium metal phosphate and carbon source to form the particulate carbon-coated lithium metal phosphate.

6. A process according to claim 5 wherein the iron (II) salt is selected from iron (II) sulfate, iron (II) oxalate, or iron (II) chloride.

7. A process according to claim 5 wherein the acidic solution of an iron (II) salt comprises at least 5 wt % iron, preferably at least 6 wt % iron, more preferably at least 8 wt % iron.

8. A process according to claim 5 wherein the adsorbent material comprises a crosslinked polystyrene resin modified with 2-aminomethylpyridine functional groups.

9. A process according to claim 5 wherein the adsorbent material comprises a silicon polymer composite modified with 2-aminomethylpyridine functional groups.

10. A process according to claim 5 wherein the 2-aminomethylpyridine functional groups are bis(2-pyridylmethyl)amine functional groups.

11. A process according to claim 5 wherein the iron (II) precursor solution has a copper content of less than 0.1 ppm, preferably less than 0.01 ppm.

12. Particulate carbon-coated lithium metal phosphate obtainable by a process according to claim 5.

13. An electrode for a secondary lithium ion battery comprising particulate carbon-coated lithium metal phosphate according to claim 1.

14. A secondary lithium ion battery comprising an electrode according to claim 13.

15. (canceled)
